(19) United States
(12) Patent Application Publication
(10) Pub. No.: US 2008/0158219 A1
(43) Pub. Date: Jul. 3, 2008

(54) Plasma display device, driving device, and method of driving the same

(76) Inventors: Sang-Min Nam, Suwon-si (KR); Jung-Pil Park, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/987,537

(22) Filed: Nov. 30, 2007

(30) Foreign Application Priority Data
Jan. 3, 2007 (KR) 10-2007-0000542

(51) Int. Cl. G06F 3/038

(52) U.S. Cl. 345/212

(57) ABSTRACT

A plasma display device includes a plurality of first electrodes, a plurality of first transistors connected between the first electrodes and a first power source, a plurality of second transistors connected to the first electrodes, a plurality of first capacitors connected between the first and second transistors, a plurality of third transistors connected between the second transistors and a second power source, and a plurality of fourth transistors connected between the first power source and the third transistors.

### BACKGROUND OF THE INVENTION

1. Field of the Invention

Embodiments of the present invention relate to a plasma display device, a driving device of the plasma display device, and a method of driving the same.

2. Description of the Related Art

A plasma display device refers to a flat display device capable of displaying images via a gas discharge phenomenon. A conventional plasma display device may include a plasma display panel (PDP) having a plurality of discharge cells filled with discharge gas, such that the discharge cells may be arranged in a predetermined pattern between two panels. Application of a voltage via discharge electrodes, i.e., scan and sustain electrodes, on the panels to the discharge gas in the discharge cells may generate vacuum ultraviolet (VUV) light, thereby triggering excitation of a photoluminescent material in the discharge cells to emit visible light.

In a conventional PDP, one frame of a PDP may include a plurality of subfields, each subfield having a weighted value assigned thereto. Grayscales may be expressed by a combination of the weights of the corresponding subfields to perform a display operation. Each subfield may have a reset period, an address period, and a sustain period. In the reset period, a reset waveform may be applied to the scan electrodes to initialize the discharge cells. In the address period, scan pulses may be applied to the scan electrodes to select discharge cells to be operated, i.e., discharge cells to emit light. In the sustain period, scan and sustain pulses may be alternately applied to the scan and sustain electrodes of the selected discharge cells to generate a sustain discharge therein, thereby performing the display operation, i.e., triggering light emission in order to display images.

In order to perform the display operation, different voltages may be applied to the scan and sustain electrodes at different times, i.e., reset period, address period, and/or sustain period, thereby requiring separate scan and sustain driving boards on a chassis base of the PDP in order to drive the scan and sustain electrodes, respectively. However, separate scan and sustain driving boards may require a large installation space on the chassis base of the PDP, and may increase manufacturing costs of the PDP.

The above information disclosed in this Background section is only for enhancement of understanding of the background of the invention, and therefore, it may contain information that does not form the prior art that is already known in this country to a person of ordinary skill in the art.

### SUMMARY OF THE INVENTION

Embodiments of the present invention are therefore directed to a plasma display device, a driving device, and a method of driving the same, which substantially overcome one or more of the disadvantages of the related art.

It is therefore a feature of an embodiment of the present invention to provide a plasma display device having a reduced-size sustain driving board.

It is another feature of an embodiment of the present invention to provide a plasma display device exhibiting improved discharge characteristics.

It is yet another feature of an embodiment of the present invention to provide a plasma display device having reduced manufacturing costs.

It is still another feature of an embodiment of the present invention to provide a driving device for a plasma display device having any one of the above features.

It is yet another feature of an embodiment of the present invention to provide a method of driving a plasma display device having any one of the above features.

At least one of the above and other features and advantages of the present invention may be realized by providing a plasma display device, including a plurality of first electrodes, a plurality of first transistors, each first transistor having a first terminal electrically connected to a corresponding first electrode of the plurality of first electrodes and a second terminal electrically connected to a first power source, the first power source configured to supply a first voltage, a plurality of second transistors, each second transistor having a first terminal electrically connected to a corresponding first electrode of the plurality of first electrodes, a plurality of first capacitors, each first capacitor electrically connected between a second terminal of a corresponding first transistor and a second terminal of a corresponding second transistor, a plurality of third transistors, each third transistor having a first terminal electrically connected to a second terminal of a corresponding second transistor and a second terminal electrically connected to a second power source, the second power source configured to supply a second voltage, and a plurality of fourth transistors, each fourth transistor having a first terminal electrically connected to the first power source and a second terminal electrically connected to the first terminal of a corresponding third transistor.

The plasma display device may further include a controller configured to turn on the plurality of first transistors in a first period and in a third period, to turn on the plurality of second and third transistors in a second period and in a fourth period, and to turn on the plurality of fourth transistors in a third period. The first period may be a falling reset period and an address period, the second period may be a sustain period, the third period may be a pre-reset period, and the fourth period may be a rising reset period. The plasma display device may further include a plurality of diodes, each diode connected between a corresponding first transistor and the first power source.

The first electrodes may be sustain electrodes. The first voltage may be a positive voltage, and the second voltage may be a ground voltage. The plasma display device may further include a first electrode driving board to drive the plurality of first electrodes. The plasma display device may further include a second electrode driving board to drive a plurality of second electrodes, the second electrode driving board being smaller than the first electrode driving board.

At least one of the above and other features and advantages of the present invention may be further realized by providing a method of driving a display device having a plurality of first and second electrodes, including applying a first voltage to the plurality of first electrodes in a first period by turning on a plurality of first transistors electrically connected between a first power source for supplying the first voltage and the plurality of first electrodes, applying a second voltage to the plurality of first electrodes in a second period by turning on a plurality of second transistors electrically connected to a second power source for supplying the second voltage, so that a plurality of first capacitors are charged with a third voltage, applying a fourth voltage to the plurality of first electrodes in a third period by turning on the plurality of the first transistors and a plurality of third transistors electrically connected to the first power source, the fourth voltage being equal to a sum of the first and third voltages, and applying the second voltage to the plurality of first electrodes in a fourth period by turning on the plurality of second transistors.

Turning on the second transistors may include turning on a first set of the second transistors being in electrical communication with the first electrodes, and turning on a second set of the second transistors electrically connected between the first set of the second transistors and the second power source. Charging the first capacitors may include connecting each first capacitors between a corresponding first transistors and a corresponding transistor of the first set of the second transistors. The third voltage may equal the first voltage and the second voltage is a ground voltage. The first period may be a falling reset period and an address period, the second period may be a sustain period, the third period may be a pre-reset period, and the fourth period may be a rising reset period. The first electrodes may be sustain electrodes, and the second electrodes may be scan electrodes.

At least one of the above and other features and advantages of the present invention may be also realized by providing a device for driving a plasma display device having first and second electrodes, including a first path between a first power source configured to output a first voltage and the first electrodes, the first path configured to supply the first voltage to the first electrodes, a second path between the first power source and a second power source configured to output a second voltage, the second path configured to apply the second voltage to the first electrodes and to charge a plurality of first capacitors connected between the first and second power sources with a third voltage, a third path between the first power source and the first electrodes, the third path configured to apply a fourth voltage to the first electrodes via the first capacitors, and a fourth path between the second power source and the first electrodes, the fourth path configured to apply a second voltage to the first electrodes.

The first path may include a plurality of first transistors connected between the first electrodes and the first power source, the second path may include a plurality of second transistors connected between the first capacitors and the second power source, the third path may include the first transistors and a plurality of third transistors, each third transistor connected between the first power source and a respective first capacitor, and the fourth path may include the second transistors and a plurality of fourth transistors, each fourth transistor connected between respective first electrodes and first capacitors. The first path may further include a plurality of diodes connected between the first transistors and the first power source.

The first transistors may be configured to be turned on to supply the first voltage to the first electrodes, the second and fourth transistors may be configured to be turned on to charge the first capacitors with the third voltage, the first and third transistors may be configured to be turned on to supply the fourth voltage to the first electrodes, and the second and fourth transistors may be configured to be turned on to supply the second voltage to the first electrodes. The first electrodes may be sustain electrodes and the second electrodes are scan electrodes. The device may be configured to apply only a bias voltage to the first electrodes.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic diagram of a plasma display device according to an exemplary embodiment of the present invention;

FIG. 2 illustrates a graph of driving waveforms of a plasma display device according to an exemplary embodiment of the present invention;

FIG. 3 illustrates a circuit diagram of a sustain driving board of a plasma display device according to an exemplary embodiment of the present invention;

FIG. 4 illustrates a signal timing chart of the sustain driving board of FIG. 3; and

FIGS. 5A-5D illustrate sequential diagrams of current paths in the sustain driving board of FIG. 3 in accordance with the signal timing chart of FIG. 4.

### DETAILED DESCRIPTION OF THE INVENTION

Korean Patent Application No. 10-2007-0000542 filed on Jan. 3, 2007, in the Korean Intellectual Property Office and entitled: “Plasma Display Device, and Driving Device and Method Thereof,” is incorporated by reference herein in its entirety.

Embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of elements may be exaggerated for clarity of illustration. It will also be understood that when an element is referred to as being connected or coupled “between” two elements, it can be the only element between the two elements, or one or more intervening elements may also be present. Like reference numerals refer to like elements throughout.

It will further be understood that when voltage is maintained at a certain state, it should not be understood to strictly imply that the voltage is maintained exactly at a predetermined voltage. To the contrary, even if a voltage difference between two points varies, the voltage difference is expressed to be maintained at a predetermined voltage in the case that the variance is within a range allowed in design constraints or in the case that the variance is caused due to a parasitic component that is usually disregarded by a person of ordinary skill in the art. In addition, since threshold voltages of semiconductor elements (e.g., a transistor and a diode) are very low compared to a discharge voltage, they are considered to be 0V.

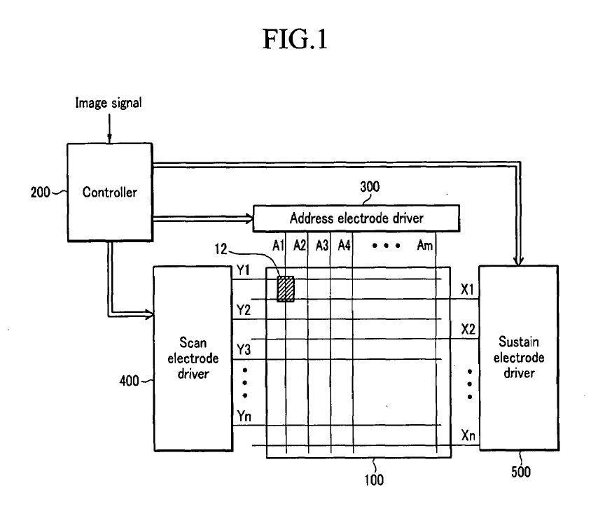

An exemplary embodiment of a plasma display device according to the present invention will now be described in more detail with reference to FIG. 1. As illustrated in FIG. 1, a plasma display device may include a plasma display panel (PDP) 100, a controller 200, an address electrode driver 300, a scan electrode driver 400, and a sustain electrode driver 500.

The PDP 100 may be any suitable PDP as determined by one of ordinary skill in the art. For example, the PDP 100 may include a plurality of address electrodes A1-Am (“A electrodes”) extending in a first direction, e.g., a column direction, and a plurality of discharge electrodes, i.e., pairs of X sustain electrodes X1-Xn (“X electrodes”) and Y scan electrodes Y1-Yn (“Y electrodes”), extending in a second direction, e.g., a row direction. The X electrodes may correspond to the Y electrodes, so the X and Y electrodes may form, e.g., an alternating pattern of X and Y electrodes, in order to perform a display operation.

The first and second directions may be perpendicular, so that the A electrodes and the pairs of X and Y electrodes may cross one another. Discharge spaces, i.e., discharge cells 12, may be formed at each intersection point of an A electrode with a pair of X and Y electrodes, as further illustrated in FIG. 1. Accordingly, each discharge cell 12 may be configured to correspond to one address electrode A and to one pair of X and Y electrodes.

The controller 200 of the plasma display device may receive an external image signal, and may output corresponding address, sustain, and scan driving control signals to the address electrodes A and the discharge X and Y electrodes, respectively. The controller 200 may control the plasma display device by dividing one frame into a plurality of subfields having respective brightness weight values. Each of the subfields may include a reset period, an address period, and a sustain period according to time intervals.

The address electrode driver 300 of the plasma display device may receive the address driving control signal from the controller 200, and may apply a corresponding driving voltage to the A electrodes in order to select discharge cells 12 for display operation, i.e., predetermined discharge cells 12 to emit light in the sustain period.

The scan electrode driver 400 of the plasma display device may receive the scan driving control signal from the controller 200, and may apply a corresponding driving voltage, i.e., a scan pulse, to the Y electrodes.

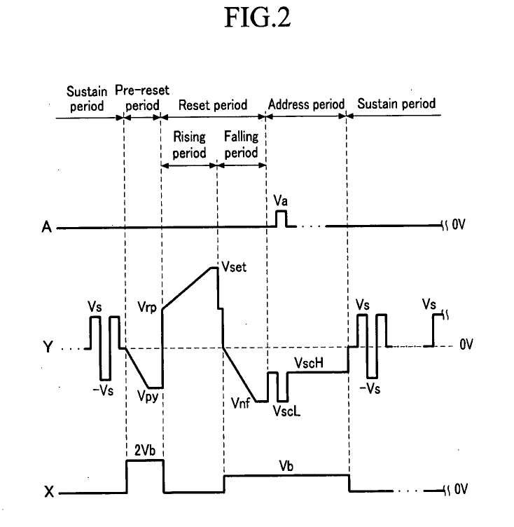

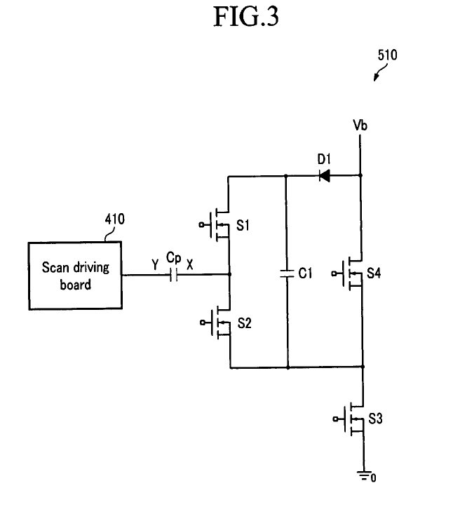

The sustain electrode driver 500, i.e., a sustain electrode driving board, of the plasma display device may receive the sustain driving control signal from the controller 200, and may apply a bias voltage to the X electrodes, as opposed to applying a corresponding sustain pulse thereto. The sustain electrode driver 500 may include a driving circuit 510, as illustrated in FIG. 3, configured to supply the bias voltage to the X electrodes, as will be discussed in more detail below with respect to FIGS. 2-5. It should be noted that the an “electrode driver” and an “electrode driving board” may be used hereinafter interchangeably.

The plasma display device according to an embodiment of the present invention may be driven as follows. One subfield of the PDP 100 may include a reset period, an address period, and a sustain period, while the reset period may include a rising period and a falling period. Driving waveforms applied to the A electrodes and the X and Y electrodes in the reset, address, and sustain periods are illustrated in FIG. 2.

In the rising reset period, as illustrated in FIG. 2, voltage applied to the Y scan electrode may gradually increase from a voltage Vrp to a voltage Vset, e.g., in a ramp pattern. In the rising reset period, voltages of the A and X electrodes may be maintained at a reference voltage, e.g., 0 V. While the voltage of the Y electrode increases in the reset rising period, a weak discharge may occur between the Y and X electrodes and between the Y and A electrodes, thereby causing formation of negative (−) wall charges on the Y electrodes and formation of positive (+) wall charges on the X and A electrodes. The gradual voltage increase on the Y electrodes may cause the weak discharge in the discharge cells 12 to form the wall charges in such a way that a sum of an externally applied voltage and the wall voltage of the discharge cells 12 may be maintained at a discharge firing voltage. Since in the reset period, all discharge cells 12 are initialized, the voltage Vset may be high enough to generate a discharge in all the discharge cells 12.

In the falling reset period, the voltage of the Y electrodes may gradually decrease from a voltage 0 V to a voltage Vnf, while the reference voltage of the A electrodes may be maintained, and a voltage Vb may be applied to the electrodes X. The voltage of the Y electrodes may be reduced from Vset to 0 V between the rising and falling periods of the reset period. During the gradual voltage decrease of the Y electrodes from 0 V to Vnf, a weak discharge may occur between the Y and X electrodes and between the Y and A electrodes, thereby causing removal of the previously formed negative (−) wall charges on the Y electrodes and of the positive (+) wall charges on the X and A electrodes. Removal of the wall charges may initialize the discharge cells 12. The magnitude of the voltages Vnf and Vb, i.e., voltages of the Y and X electrodes at the end of the reset falling period, respectively, may be about the discharge firing voltage between the Y and X electrodes, so the wall voltage between the Y and X electrodes may be close to about 0 V, thereby preventing discharge in non-emitting discharge cells in the sustain period.

Next, a scan pulse having a voltage VscL may be sequentially applied to the plurality of Y electrodes in the address period, while the X electrodes may be maintained at the voltage Vb. Simultaneously, a voltage Va may be applied to A electrodes extending through discharge cells 12 to be selected. An address discharge may occur between A electrodes receiving the voltage Va and Y electrodes receiving the voltage VscL, and between Y electrodes receiving voltage VscL and X electrodes receiving the voltage Vb. Accordingly, positive (+) wall charges may be formed on the Y electrode and negative (−) wall charges may be formed on the A and X electrodes.

Subsequently, in the sustain period, a high-level voltage Vs and a low-level voltage (−Vs) may be alternately applied to the Y electrodes, while the X and A electrodes may be maintained at a reference voltage, e.g., 0 V. Accordingly, a discharge may be generated in the discharge cells 12 due to the alternating voltages Vs/(−Vs) and the wall voltage formed between the Y and X electrodes during the preceding address period. A process of applying scan pulses to the Y electrodes may be repeated a predetermined number of times, i.e., the predetermined number may correspond to a weighted value represented by a corresponding subfield.

As further illustrated in FIG. 2, one subfield may further include a pre-reset period in order to minimize a discharge between the Y and A electrodes in the reset period. In detail, when the wall voltages between the X and Y electrodes and between the A and Y electrodes are about 0 V, the discharge between the A and Y electrodes may occur before the discharge between the X and Y electrodes in a reset period of a subsequent subfield, thereby triggering a strong discharge between the A and Y electrodes.

In further detail, when the reset period in a certain subfield ends, the wall voltage between the X and Y electrodes and the wall voltage between the A and Y electrodes may be about 0 V, and non-emitting discharge cells 12 may maintain the state of the wall charges set in the reset period, i.e., about 0 V. However, since the discharge firing voltage between the A and Y electrodes may be set to be lower than the discharge firing voltage between the X and Y electrodes, the voltage increase of the Y electrode in the subsequent subfield reset period, may cause the voltage between the A and Y electrodes to be higher than the discharge firing voltage, thereby triggering a strong discharge, as opposed to a weak discharge, between the A and Y electrodes.

Accordingly, as illustrated in FIG. 2, the pre-reset period may be provided before the rising reset period in order to facilitate control of wall voltage formed between the Y and X electrodes. More specifically, in the pre-reset period, the voltage of the Y electrodes may gradually decrease from a reference voltage, e.g., 0 V, to a voltage Vpy, while the X electrodes may be maintained at a voltage higher than the voltage Vb, e.g., a voltage of 2 Vb. Accordingly, positive (+) wall charges and negative (−) wall charges may be formed on the Y and X electrodes, respectively. Such formation of wall charges may cause the discharge between the Y and X electrodes to occur before the discharge between the Y and A electrodes in the rising reset period, thereby reducing a strength of discharge between the A and Y electrodes in the reset period.

As described previously, the X electrodes may require only bias voltage. More specifically, the reference voltage applied to the X electrodes may be a voltage of 2 Vb in the pre-reset period, a voltage of Vb in the falling reset period and the address period, and a reference voltage of, e.g., about 0 V, in the other periods. Accordingly, a reset operation, an address operation, and a sustain operation may be performed by using only driving waveforms, i.e., scan pulses, applied to the Y electrodes. Use of only scan pulses to drive the plasma display device, i.e., application of only bias voltage to the X electrodes, may substantially decrease a size of the sustain electrode driving board 500, e.g., as compared to an electrode driving board employed to apply sustain discharge pulses to a plurality of X electrodes or as compared to the scan electrode driving board 400. The reduced size of the sustain electrode driving board 500 may be due to the driving circuit 510 thereof.

The driving circuit 510 of the sustain driving board 500 may include first, second, third, and fourth transistors S1, S2, S3, and S4, a capacitor C1, and a diode D1, as illustrated in FIG. 3. It should be noted that FIG. 3 illustrates only a connection between the driving board 510 and the plurality of X electrodes, and that the driving board 510 may also be connected to the plurality of Y electrodes. It should be further noted that the X and Y electrodes are shown as single electrodes for convenience of illustration only, and a plurality of sustain electrodes X1-Xn and scan electrodes Y1-Yn may be included in the scope of the present invention.

The first through fourth transistors S1-S4 in FIG. 3 may be any type of transistors having a n-channel field effect and forming a body diode in a direction from a source to a drain, e.g., n-channel metal oxide semiconductor (NMOS) transistors. In this respect, it should be noted that even though each of the first through fourth transistors S1-S4 is illustrated as one transistor, each of the first through fourth transistors S1-S4 may include a plurality of transistors connected in parallel. It should further be noted that a capacitive component formed by one X electrode and one Y electrode is illustrated in FIG. 3 as a panel capacitor Cp. The Y electrodes may be connected to a scan driving board 410.

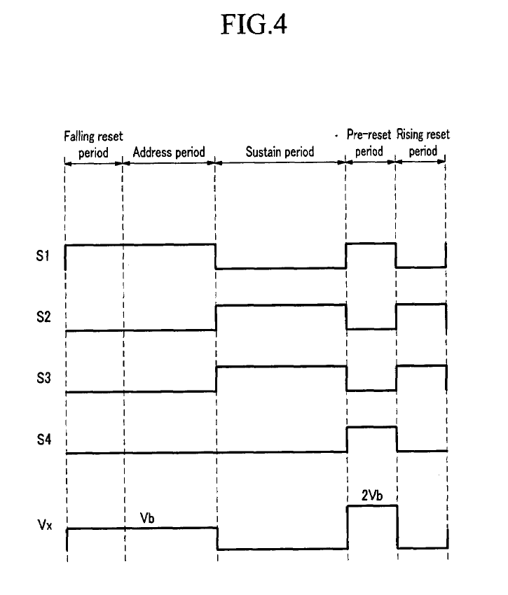

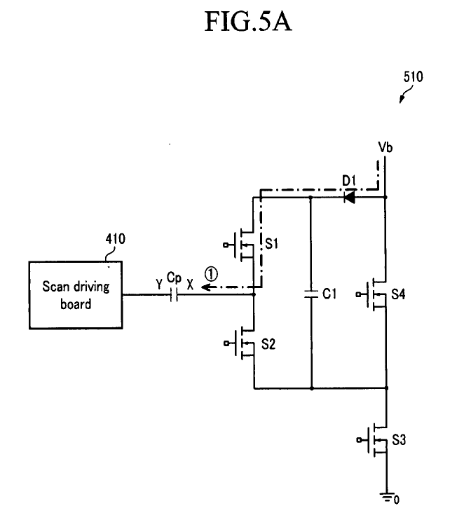

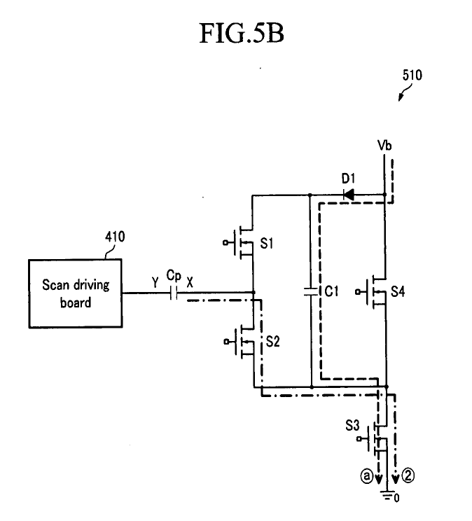

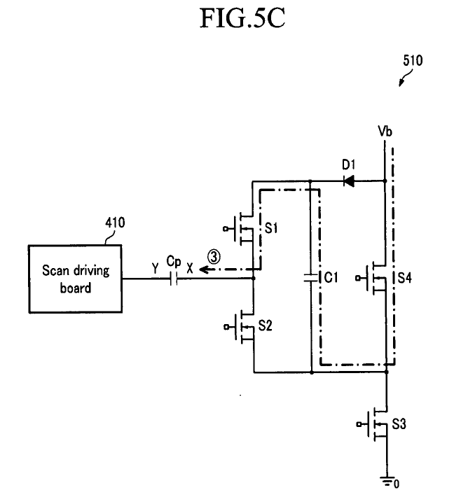

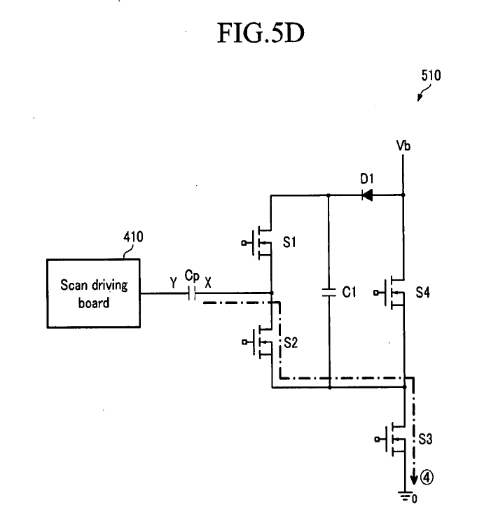

As further illustrated in FIG. 3, the first transistor S1 may have a source connected to the X electrode and a drain connected to a cathode of the diode D1. An anode of the diode D1 may be connected to a first power source, i.e., a power source supplying voltage Vb. The second transistor S2 may have a drain connected to the X electrode and a source connected to the third transistor S3. The third transistor S3 may have a drain connected to the source of the second transistor S2 and a source connected to a second power source, i.e., a power source supplying 0 V. The fourth transistor S4 may have a source connected to the drain of the third transistor S3 and a drain connected to the first power source. The capacitor C1 may be connected between the drain of the first transistor S1 and the source of the second transistor S2. Operation of the driving board 510 illustrated in FIG. 3 will be described in more detail below with reference to FIG. 4 and FIGS. 5A-5D illustrating a signal timing chart and corresponding operational states of the driving board 510.

As illustrated in FIGS. 4 and 5A, in the address period, the second, third, and fourth transistors S2, S3, and S4 may be turned off, and the first transistor S1 may be turned on. Accordingly, as illustrated in FIG. 5A, a first path \textcircled{1} may be formed from the first power source through the diode D1, the first transistor S1, and the panel capacitor Cp toward the X electrode, so that a bias voltage Vx, e.g., voltage Vb, may be applied to the X electrode. In other words, the first path \textcircled{1} may maintain voltage of the X electrode at the voltage Vb in the address period and in the preceding falling reset period, as illustrated in FIG. 4. An operational state of the first through fourth transistors S1-S4 in the address and falling reset periods may be unchanged.

As illustrated in FIG. 4 and FIG. 5B, in the sustain period, the first transistor S1 may be turned off, and the second and third transistors S2 and S3 may be turned on. The operational state of the fourth transistor S4 may remain unchanged. Accordingly, as illustrated in FIG. 5B, second paths \textcircled{2} and \textcircled{a} may be formed. More specifically, path \textcircled{2} may be formed from the panel capacitor Cp through the second and third transistors S2 and S3 toward the second power source, so that 0 V may be applied and maintained at the X electrode. Path \textcircled{a} may be formed from the first power source, through the diode D1, the capacitor C1, and the third transistor S3 toward the second power supply source, so that the capacitor C1 may be charged with the voltage Vb. The first and fourth transistors S1 and S4 may have sources thereof maintained at 0 V and drains thereof maintained at Vb. Therefore, transistors having a withstand voltage of Vb may be used as the first and fourth transistors S1 and S4.

As illustrated in FIG. 4 and FIG. 5C, in the pre-reset period, the second and third transistors S2 and S3 may be turned off, and the first and fourth transistors S1 and S4 may be turned on. Accordingly, as illustrated in FIG. 5C, a third path \textcircled{3} may be formed. More specifically, the third path \textcircled{3} may be formed from the first power source, through the fourth transistor S4, the capacitor C1, the first transistor S1, and the panel capacitor Cp toward the electrode X, so that a voltage of 2 Vb may be applied thereto. In other words, since the capacitor C1 is charged with voltage Vb in the sustain period and a voltage Vb is transferred through the third path \textcircled{3} in the pre-reset period through the charged capacitor C1 toward the X electrode, the bias voltage Vx applied to the X electrode may be a total voltage of 2 Vb. The third transistor S3 may have its source and drain maintained at 0 V and Vb, respectively, and therefore, a transistor having a withstand voltage of voltage Vb may be used as the third transistor S3.

As illustrated in FIG. 4 and FIG. 5D, in the rising reset period, the first and fourth transistors S1 and S4 may be turned off, and the second and third transistors S2 and S3 may be turned on. Accordingly, as illustrated in FIG. 5D, a fourth path \textcircled{4} may be formed. More specifically, the fourth path \textcircled{4} may be formed from the panel capacitor Cp, through the second transistor S2 and the third transistor S3 toward the second source, so that 0 V may be applied to the X electrode.

The plasma display device according to embodiments of the present invention may be advantageous in providing a sustain driving board with a driving circuit having a reduced number of power sources and transistors with minimized withstand voltage. More specifically, the sustain driving board of the plasma display device may include one power source and one capacitor, instead of two power sources, in order to generate two bias voltages. Further, the driving circuit of the sustain driving board may apply voltage of up to 2 Vb to the X electrodes, while using transistors designed to have a withstand voltage of Vb. Such a reduced withstand voltage may cause a decreased resistance value in the transistors, thereby minimizing electrical loss and heat generation therein. In addition, the sustain driving board may apply bias voltage to the X electrodes only in the pre-reset period, falling reset period, and address period, thereby facilitating operation of the plasma display device in other periods via scan pulses supplied to the Y scan electrodes by the scan driving board. As such, a size of the sustain driving board may be reduced, thereby substantially minimizing a space required by the scan and sustain driving boards on a chassis base of the plasma display device. As a result, it is possible to reduce costs of the circuits required for driving the plasma display device and overall manufacturing costs of the plasma display device.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device, comprising:
a plurality of first electrodes;
a plurality of first transistors, each first transistor having a first terminal electrically connected to a corresponding first electrode of the plurality of first electrodes and a second terminal electrically connected to a first power source, the first power source configured to supply a first voltage;
a plurality of second transistors, each second transistor having a first terminal electrically connected to a corresponding first electrode of the plurality of first electrodes;
a plurality of first capacitors, each first capacitor electrically connected between the second terminal of a corresponding first transistor and a second terminal of a corresponding second transistor;
a plurality of third transistors, each third transistor having a first terminal electrically connected to the second terminal of a corresponding second transistor and a second terminal electrically connected to a second power source, the second power source configured to supply a second voltage; and
a plurality of fourth transistors, each fourth transistor having a first terminal electrically connected to the first power source and a second terminal electrically connected to the first terminal of a corresponding third transistor.

2. The plasma display device as claimed in claim 1, wherein the first electrodes are sustain electrodes.

3. The plasma display device as claimed in claim 1, further comprising a controller configured to turn on the plurality of first transistors in a first period and in a third period, to turn on the plurality of second and third transistors in a second period and in a fourth period, and to turn on the plurality of fourth transistors in a third period.

4. The plasma display device as claimed in claim 3, wherein the first period is a falling reset period and an address period, the second period is a sustain period, the third period is a pre-reset period, and the fourth period is a rising reset period.

5. The plasma display device as claimed in claim 1, wherein the first voltage is a positive voltage and the second voltage is a ground voltage.

6. The plasma display device as claimed in claim 1, further comprising a plurality of diodes, each diode connected between a corresponding first transistor and the first power source.

7. The plasma display device as claimed in claim 1, further comprising a first electrode driving board to drive the plurality of first electrodes.

8. The plasma display device as claimed in claim 7, further comprising a second electrode driving board to drive a plurality of second electrodes, the second electrode driving board being smaller than the first electrode driving board.

9. A method of driving a display device having a plurality of first and second electrodes, comprising:
applying a first voltage to the plurality of first electrodes in a first period by turning on a plurality of first transistors electrically connected between a first power source for supplying the first voltage and the plurality of first electrodes;
applying a second voltage to the plurality of first electrodes in a second period by turning on a plurality of second transistors electrically connected to a second power source for supplying the second voltage, so that a plurality of first capacitors are charged with a third voltage;
applying a fourth voltage to the plurality of first electrodes in a third period by turning on the plurality of the first transistors and a plurality of third transistors electrically connected to the first power source, the fourth voltage being equal to a sum of the first and third voltages; and
applying the second voltage to the plurality of first electrodes in a fourth period by turning on the plurality of second transistors.

10. The method as claimed in claim 9, wherein turning on the second transistors includes turning on a first set of the second transistors being in electrical communication with the first electrodes, and turning on a second set of the second transistors electrically connected between the first set of the second transistors and the second power source.

11. The method as claimed in claim 10, wherein charging the first capacitors includes connecting each first capacitors between a corresponding first transistors and a corresponding transistor of the first set of the second transistors.

12. The method as claimed in claim 9, wherein the third voltage equals the first voltage and the second voltage is a ground voltage.

13. The method as claimed in claim 9, wherein the first period is a falling reset period and an address period, the second period is a sustain period, the third period is a pre-reset period, and the fourth period is a rising reset period.

14. The method as claimed in claim 9, wherein the first electrodes are sustain electrodes and the second electrodes are scan electrodes.

15. A device for driving a plasma display device having first and second electrodes, comprising:
a first path between the first electrodes and a first power source configured to output a first voltage, the first path configured to supply the first voltage to the first electrodes;
a second path between the first power source and a second power source configured to output a second voltage, the second path configured to apply the second voltage to the first electrodes and to charge a plurality of first capacitors connected between the first and second power sources with a third voltage;
a third path between the first power source and the first electrodes, the third path configured to apply a fourth voltage to the first electrodes via the first capacitors; and
a fourth path between the second power source and the first electrodes, the fourth path configured to apply a second voltage to the first electrodes.

16. The device as claimed in claim 15, wherein:
the first path includes a plurality of first transistors connected between the first electrodes and the first power source;
the second path includes a plurality of second transistors connected between the first capacitors and the second power source;
the third path includes the first transistors and a plurality of third transistors, each third transistor connected between the first power source and a respective first capacitor; and
the fourth path includes the second transistors and a plurality of fourth transistors, each fourth transistor connected between respective first electrodes and first capacitors.

17. The device of claim 16, wherein the first path further comprises a plurality of diodes connected between the first transistors and the first power source.

18. The device as claimed in claim 16, wherein:
the first transistors are configured to be turned on to supply the first voltage to the first electrodes;
the second and fourth transistors are configured to be turned on to charge the first capacitors with the third voltage;
the first and third transistors are configured to be turned on to supply the fourth voltage to the first electrodes; and
the second and fourth transistors are configured to be turned on to supply the second voltage to the first electrodes.

19. The device as claimed in claim 15, wherein the first electrodes are sustain electrodes and the second electrodes are scan electrodes.

20. The device as claimed in claim 15, wherein the device is configured to apply only a bias voltage to the first electrodes.
